(19) United States
(12) Patent Application Publication
(10) Pub. No.: US 2025/0285543 A1
(43) Pub. Date: Sep. 11, 2025

(54) SYSTEM FOR PLANNING A FLIGHT PATH FOR SURVEYING A REGION OF INTEREST

(71) Applicant: ideaForge Technology Limited, Navi Mumbai (IN)

(72) Inventors: Lakshmi NARAYANAN, Navi Mumbai (IN); Pradeep Vinay PANDURANGI, Navi Mumbai (IN); Ankit MEHTA, Navi Mumbai (IN)

(73) Assignee: ideaForge Technology Limited, Navi Mumbai (IN)

(21) Appl. No.: 19/074,386

(22) Filed: Mar. 9, 2025

(30) Foreign Application Priority Data
Mar. 11, 2024 (IN) 202421017459

(51) Int. Cl. G08G 5/34; G08G 5/23; G08G 5/24; G08G 5/26; G08G 5/57; G08G 5/59

(52) U.S. Cl. CPC G08G 5/34; G08G 5/23; G08G 5/24; G08G 5/26; G08G 5/57; G08G 5/59

(57) ABSTRACT

A system (100) for planning a flight path for a survey of a ROI comprises at least one UAV (102). a flight control unit (104) and a flight planning unit (106). Flight planning unit (106) creates a main flight path (302) covering the ROI, identifies an area of interest based on trigger data within the ROI, creates a boundary (304) around the identified area of interest, and creates an additional flight path (306), which is contiguous to the main flight path (302), for the identified area of interest. The trigger data may be captured during the main flight path using sensors mounted on the UAV and the flight path planned/generated in real-time during the flight, or may be fed by user. The main flight path (302) and the additional flight path (306) are any of a back-and-forth linear paths or spiral path flight paths.

### CROSS-REFERENCE TO RELATED APPLICATION

Benefit is claimed to Indian patent application Ser. No. 202421017459, filed Mar. 11, 2024, the contents of which are incorporated by reference herein in their entirety.

### TECHNICAL FIELD

The present disclosure relates generally to the field of Unmanned Aerial Vehicles (UAVs). In particular, the present disclosure relates to the navigation of UAVs. More particularly, it pertains to a system for planning a flight path for surveying a region of interest (ROI).

### BACKGROUND

Background description includes information that may be useful in understanding the present invention. It is not an admission that any of the information provided herein is prior art or relevant to the presently claimed invention, or that any publication specifically or implicitly referenced is prior art.

Aerial Vehicles, such as aircrafts and UAVs are widely employed for surveying infrastructure, including but not limited to roads, buildings, crowd monitoring, power lines, pipelines, unauthorized infiltration, and similar applications. Traditional methods of surveying regions of interest involve the UAV/aircraft following a predetermined flight path generated by a ground station based on past data, covering the entire area of interest. The commonly utilized flight path patterns include back-and-forth (BF) and spiral (SP), with the former consisting of straight lines crossed in both directions, and the latter involving manoeuvres around the external vertices with a reduction in radius towards the central point.

However, a critical limitation arises when dealing with areas of varying interest within the region being surveyed (also referred to as Region Of

Interest (ROI), herein). For example, a portion of the ROI may need a closer mapping based on certain parameters, such as a population dense area like a city. The conventional approach mandates that, if specific regions require more detailed mapping due to higher population density, users must initiate separate flights. In such cases, users manually select the dense area as a newly selected area, triggering the creation of a distinct standard flight path. This practice results in multiple flights over the same area, hampering operational efficiency, increasing costs, and prolonging the surveying process.

Thus, there is a need to overcome the drawbacks, shortcomings, and limitations associated with the conventional surveying systems and methods by providing improved surveying systems and methods that enhance operational efficiency, minimize redundant flights, and provide a more dynamic and responsive solution to the demands of modern infrastructure surveying.

A general object of the present disclosure is to provide an effective solution for a survey of a region of interest (ROI).

An object of the present disclosure is to overcome the above mentioned drawbacks, shortcomings, and limitations associated with the conventional surveying systems and methods.

Another object of the present disclosure is to reduce the number of flights for surveying selected regions of interest ROI.

Another object of the present disclosure is to develop an improved, efficient, and cost-effective system for creating an additional flight path based on the population density of a selected ROI for an in-depth survey.

Another object of the present disclosure is to design and develop an improved, efficient, and cost-effective system that adapts the additional flight path while flying on a primary flight path.

Yet another object of the present disclosure is to prevent potential damages to the UAVs during survey of the selected ROI.

Still another object of the present disclosure is to generate an efficient flight path.

### SUMMARY

Aspects of the present disclosure relate to systems and methods for planning a flight path for surveying a region of interest (ROI), wherein the flight path is planned keeping in view specific regions that require more detailed mapping for reasons depending on the type of servey. Specifically, the disclosed systems and methods plan an additional flight path covering the specific regions that require more detailed mapping, where the additional flight path is contagious to a main flight path, thereby eliminating the need for repeated fights. In different embodiments the region of interest may be predefined based on a map inputted through a user interface, or may be identified in real time based on captured data (referred to as trigger data) during the flight by sensors mounted on the UAV, or from an already available database indicative of chracterstics of the region of interest.

In an aspect, the disclosed system for planning a flight path for a survey of a region of interest (ROI) includes at least one unmanned aerial vehicle (UAV) to fly over the ROI for collecting predefined data, and having a flight control unit. The system further includes a flight planning unit operatively coupled with the flight control unit, the flight planning unit comprises one or more processors operatively coupled to a memory storing instructions executable by the processor, wherein the flight planning unit is configured to: create, at least one main flight path covering the ROI; identify, at least one area of special interest (also referred to as area of interest and the two terms are used interchangeably, herein) within the ROI; create, at least one additional flight path for the identified area of special interest. The at least one additional flight path is contiguous to the at least one main flight path.

In an embodiment, the at least one area of special interest may be any of an area with higher population density, an area with lower population density, an area where anomalies, unique features, or critical conditions are suspected (e.g., cracks in infrastructure, environmental hazards, or crop disease zones), locations of strategic significance within the ROI, such as sensitive assets, high-value resources, or targeted areas in military or surveillance applications, an area of interest for environmental studies, such as endangered species zones, wetlands, or areas prone to erosion or flooding, an area exhibiting rapid changes that require closer monitoring, such as landslides, glacier movements, or evolving disaster zones. and an area with an unusual happening, such as but not limited to, presence of a crowd, presence of smoke, presence of fire, presence of a gas.

In an embodiment, the flight planning unit may be configured to create a boundary around the identified area of special interest and detect if the main flight path intersects the created boundary around the identified area of special interest. Further, the flight planning unit creates the additional flight path covering the identified area of special interest, if it is detected that the main flight path intersects the boundary around the identified area of special interest.

In an alternate embodiment, when it is detected that the main flight path does not intersect the created boundary around the identified area of special interest the flight planning unit may be configured to ascertain a point on the created boundary around the identified area of special interest that is closest to the main flight path; and create the additional flight path covering the identified area of special interest, such that the additional flight path starts and terminates at the ascertained closest point on the boundary around the identified area of special interest. Accordingly, the flight planning unit may be configured to modify the main flight path to take a detour towards the ascertained closest point on the boundary around the identified area of special interest.

In an embodiment, the boundary shape may be any of a polygon, rectangle, circular, or elliptical.

In an embodiment, the main flight path and the additional flight path may be any of back-and-forth linear paths or spiral path flight paths or other pattern paths. The created additional can be denser path or wider-spaced flight path as well.

In an embodiment, the system may include a ground station communicatively coupled to the flight planning unit. The flight panning unit may be configured within any of the ground station or the UAV.

In an embodiment, the system may include a user interface operatively coupled to the flight planning unit. The user interface may be configured for inputting a map of the ROI. In addition, the user interface may be configured within the ground station or a user device.

In an embodiment, the flight planning unit may identify the area of special interest in the input map based on data inbuilt within the map. In an embodiment, the flight planning unit may identify the area of special interest based on a builtin machine learning method or AI scoring through the visually captured data, or pre-defined values that trigger it.

In an alternate embodiment, the flight planning unit may identify the area of special interest based a geographical location identified by a user in the inputted map, or entered by the user in the user interface.

In yet another alternate embodiment, the flight planning unit may identify the area of special interest in real time based on data captured during the flight.

In an embodiment, the user interface may be configured for inputting a type of survey of the ROI based on the selected survey, and a particular sensor or payload module among a plurality of sensors and payload modules is activated upon reaching the ROI.

In an embodiment, the system may include a risk analysis unit communicatively coupled to the flight planning unit. The risk analysis unit may be configured to determine a risk associated with the flight path over the ROI.

In an embodiment, the risk analysis unit may be configured to monitor one or more parameters including flight plan and battery charge, battery health, health of a body of the UAV, and geo-fence information of the ROI and the likes, to determine a risk associated with the flight path over the ROI.

Another aspect of the present disclosure pertains to a system for planning a real-time flight path for a survey of a region of interest (ROI). The system comprises at least one unmanned aerial vehicle (UAV) configured to fly over the ROI for collecting predefined data, the UAV comprising a flight planning unit; one or more sensors configured with the at least one UAV; and a control unit being embedded within the flight planning unit of the at least one UAV and operatively coupled with the one or more sensors, wherein the flight planning unit comprises one or more processors operatively coupled to a memory storing instructions executable by the processor, wherein the flight planning unit is configured to: actuate the one or more acquisition units to capture data of the ROI; identify, area with unusual happenings within the ROI based on the captured data of the ROI or using the map data; create, a boundary around the identified area with unusual happenings; and generate, a real-time additional flight path for covering the identified area with unusual happenings.

In one embodiment, the operator can select areas of unusual activity or significance within the ROI as input. Based on the type of special interest identified, the system can plan customized flight paths over these areas. These predefined flight paths may vary in attributes such as shape, speed, or other parameters, tailored to effectively survey the special interest zones within the ROI.

In an aspect, the control unit may be configured to control the one or more acquisition units to change position and direction of the one or more acquisition units during capture of data to identify the area with unusual happenings.

In different embodiments, the unusual happenings may be any or a combination of presence of a crowd, presence of smoke, presence of a gas, presence of fire, presence of one or more unidentifiable objects, flooding.

In an aspect, the control unit may be configured to obtain information on buildings, towers, population density, and mountains of the ROI from the captured data of the ROI and correspondingly modify the additional flight path of the UAVs.

Various objects, features, aspects, and advantages of the present disclosure will become more apparent from the following detailed description of preferred embodiments, along with the accompanying drawing figures in which like numerals represent features.

### BRIEF DESCRIPTION OF DRAWINGS

The accompanying drawings are included to provide a further understanding of the present invention and are incorporated in and constitute a part of this specification. The drawings illustrate exemplary embodiments of the present invention and, together with the description.

FIG. 1A illustrates an exemplary block diagram of the proposed system for planning a flight path for surveying a region of interest (ROI), elaborating its overall working, in accordance with embodiments of the present disclosure.

FIG. 1B illustrates an exemplary block diagram of the proposed system for planning a real-time flight path for surveying the region of interest (ROI), in accordance with embodiments of the present disclosure.

FIG. 2 illustrates an exemplary block diagram representing functional units of a flight planning unit associated with the system, in accordance with embodiments of the present disclosure

FIGS. 3A and 3B illustrate exemplary representation of a main flight path and an additional flight path, in accordance with embodiments of the present disclosure.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the scope of the present disclosure as defined by the appended claims.

Embodiments explain herein relate to a system for planning an efficient flight path for surveying a region of interest (ROI) by optimizing the flight path for the purpose of surveys of different types of a ROI, where the planned flight path takes into account an identified area of special interest within the ROI by creating additional flight path that is contiguous to a main flight path 302. The term “survey” is defined to encompass various UAV activities, such as image capturing, data collection, mapping, topographical analysis, topographical analysis using the UAV and its payloads.

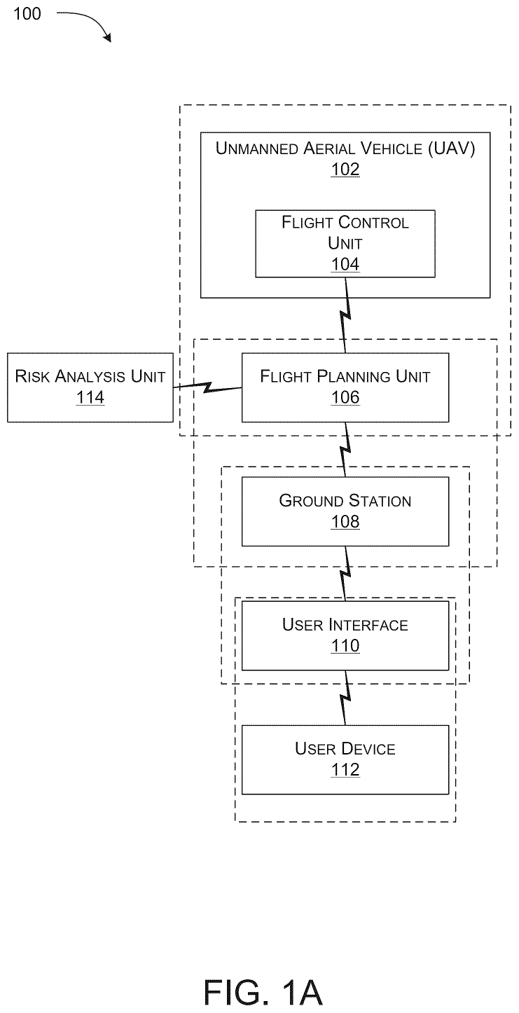

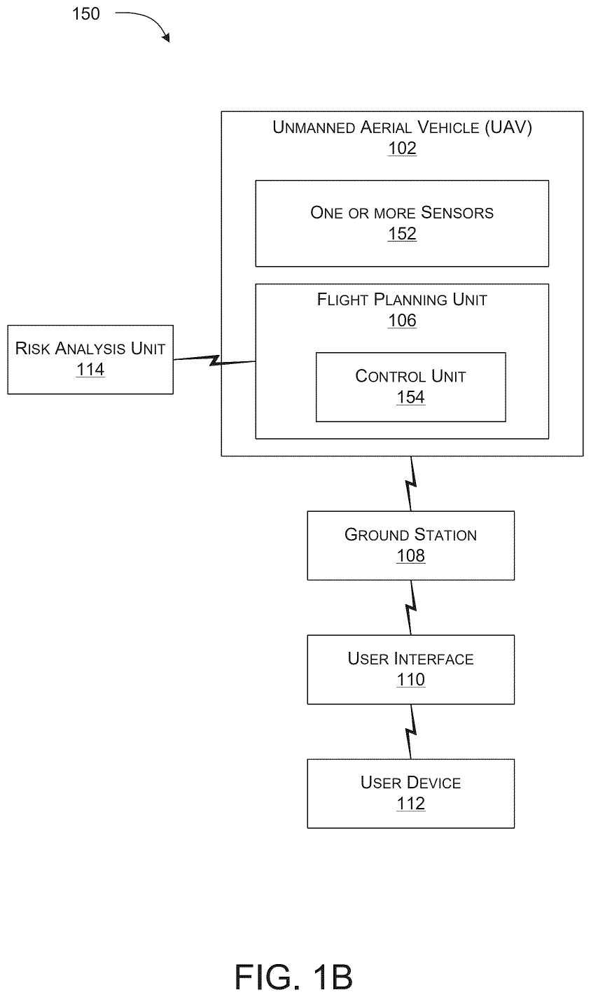

Referring to FIG. 1A, where a block diagram of the proposed system 100 for planning a flight path for a survey of a region of interest (ROI) is disclosed, the system 100 can include at least one unmanned aerial vehicle (UAV) 102 (interchangeably, referred to as UAV 102, herein) to fly over the ROI for collecting predefined data, such as overpopulated areas, remote terrain, complex topography, unknown landscapes, congested regions, skyscrapers, multi-story buildings, towers, and the like. Further, the system 100 can be configured to be used for different types of surveys, such as but not limited to, police surveillance, riot control, enemy movement, in-depth survey, safe mapping of the ROI etc. The UAV 102 includes a flight control unit 104 to control movement of the UAV 102 during the flight. The flight control unit 104 can also be configured to control/operate one or more sensors or payload modules among a plurality of sensors and payload modules that are embedded there within. The payload modules can be any from image sensors, LiDAR, radar, thermal cameras, gas sensors, multispectral and hyperspectral cameras, infrared sensors, delivery packages, communication relays, spraying systems, audio sensors, magnetometers, air quality monitors, and other specialized equipment tailored to specific applications.

In an embodiment, the system 100 can include a flight planning unit 106 configured to plan flight paths for surveying the selected ROI. The flight path can include a main flight path 302 covering the ROI and an additional flight path 306 for a closer survey of an identified area of special interest within the ROI. The flight planning unit 106 can be operatively coupled to the UAV 102 to provide a flight plan to survey the selected ROI. In addition, the system includes a user interface 110 that can be operatively coupled to the flight planning unit 106. The user interface 110 can be configured for inputting a map of the ROI and a type of survey of the ROI through a particular sensor or payload module among the plurality of sensors and payload modules of the UAV 102. Further, the user interface 110 can be configured to enable a user to select waypoints to activate and deactivate the particular sensor or payload module to collect information, upon reaching the selected waypoints.

In an embodiment, the main flight path 302 can be based on user inputted waypoints, received by the flight planning unit 106 though the user interface 110, for the UAV to travel to, such as the order in which they should be reached, a ranking or importance assigned to each waypoint or set of waypoints, and particular actions for the UAV to perform on the way to or from each waypoint. For instance, the user interface 110 can optionally enable the user to specify that upon reaching a particular waypoint, the UAV is to activate a particular sensor, or other payload module, such as an infra-red camera, or change the mode of the camera, and so on. Additionally, a user interface 110 can optionally enable the user to specify transition speeds the UAV is to use when travelling between waypoints, or between particular waypoints.

In an embodiment, the flight planning unit 106 can also obtain information regarding the height of the buildings, towers or mountains in the densely or populated area and accordingly modify its flight plans elevation as well. The flight planning unit 106 can optionally include a feature to receive approval of the generated flight path from the user or from a remote critical user before the UAV follows the automatically created flight path.

In an embodiment, the flight planning unit 106 can be configured to identify an area of special interest in the inputted map, such as by following a multifaceted approach to pinpoint areas of heightened population density on input maps. For example, the flight planning unit 106 can identify area of special interest, such as an area of special interest, by analysis of any one or a combination of urbanization patterns, a concentration of buildings, infrastructure, and tightly spaced road networks. For example, the flight planning unit 106 may scrutinize infrastructure density, assessing the concentration of transportation networks like highways, roads, and public transit routes, as they often correlate with areas of increased population density. Population density heat maps, point of interest data, and satellite imagery may also be used by the system 100 to gain comprehensive insights into regions with significant human activity, enabling more informed and efficient flight planning decisions.

The flight planning unit 106 may also use demographic data layers incorporated into some maps, such as age groups, income levels, and housing density, further enrich the analysis, providing nuanced insights into population distribution and aiding in the identification of optimal flight paths.

Furthermore, the flight planning unit 106 can also identify the densely populated urban areas by leveraging land use classification data, which distinguishes between residential, commercial, industrial, and recreational zones, based on which the system 100 can infer regions with special interest, typically associated with residential and commercial areas.

Alternatively, the flight planning unit 106 can identify an area of special interest in the inputted map based on a geographical location identified by a user in the inputted map, such as by marking the map by the user in the user interface 110. Specifically, the user interface 110, such as one in a user device, can provide information describing the traced shape to the flight planning unit 106 (e.g., coordinates associated with the selected area or regarding population), and the flight planning unit 106 can correlate the traced shape to location information in the real-world as illustrated by the imagery (e.g., GPS coordinates that correspond to the traced shape).

In yet another alternative embodiment, the flight planning unit 106 can identify an area of special interest in real time based on data captured during the flight along the main flight path.

In one embodiment, in addition to the user selected information and the population density, the flight planning unit 106 can also receive, through the user interface 110, survey or flight mission information, for instance information indicating a particular type of survey for a UAV to perform (e.g., police surveillance, in-depth survey, safe mapping etc.).

In an embodiment, the system 100 can include a ground station 108 and a user device 112. The ground station 108 can be operatively coupled to the flight planning unit 106 and the user device 112. The user interface 110 can be configured within the ground station 108 or with a user device 112. Further, the flight planning unit 106 can be configured within the ground station 108 or the UAV 102 to plan or create a flight path for surveying the selected ROI.

In an embodiment, the user device 112 may include smart devices operating in a smart environment, for example, the IoT system. In such an embodiment, the user device 112 may include, but is not limited to, smartphones, smart watches, smart sensors (e.g., mechanical, thermal, electrical, magnetic, etc.), networked appliances, networked peripheral devices, networked lighting system, communication devices, networked vehicle accessories, networked vehicular devices, smart accessories, tablets, smart television (TV), computers, smart security system, smart home system, other devices for monitoring or interacting with or for users and/or entities, or any combination thereof. In an embodiment, the user device 112 may include one or more of the following components: sensor, radio frequency identification (RFID) technology, Global Positioning System (GPS) technology, mechanisms for real-time acquisition of data, passive or interactive interface, mechanisms of outputting and/or inputting sound, light, heat, electricity, mechanical force, chemical presence, biological presence, location, time, identity, other information, or any combination thereof. A person of ordinary skill in the art will appreciate that the user device 112 may include, but is not limited to, intelligent, multi-sensing, network-connected devices, that can integrate seamlessly with each other and/or with a central server or a cloud-computing system or any other device that is network-connected.

In an embodiment, the user device 104 may include, but is not limited to, a handheld wireless communication device (e.g., a mobile phone, a smartphone, a phablet device, and so on), a wearable computer device (e.g., a head-mounted display computer device, a head-mounted camera device, a wristwatch computer device, and so on), a GPS device, a laptop computer, a tablet computer, or another type of portable computer, a media playing device, a portable gaming system, and/or any other type of computer device 112 with wireless communication capabilities, and the like. In an embodiment, the user device 112 may include, but is not limited to, any electrical, electronic, electromechanical, or equipment, or a combination of one or more of the above devices such as virtual reality (VR) devices, augmented reality (AR) devices, laptop, a general-purpose computer, desktop, personal digital assistant, tablet computer, mainframe computer, or any other computing device, wherein the user device 112 may include one or more in-built or externally coupled accessories including, but not limited to, a visual aid device such as camera, audio aid, a microphone, a keyboard, and input devices for receiving input from a user or the entity such as touch pad, touch enabled screen, electronic pen, and the like. A person of ordinary skill in the art will appreciate that the computing devices or UEs may not be restricted to the mentioned devices and various other devices may be used.

Further, the system 100 includes a risk analysis unit 114 communicatively coupled to the flight planning unit 106. The risk analysis unit 114 can be configured to determine a risk associated with the flight path over the ROI and the UAV 102. The risk analysis unit 114 can be configured to monitor one or more parameters including flight plan and battery charge, battery health, health of a body of the UAV 102, temperature information of the battery, geo-fence information of the ROI, and the likes, to determine a risk associated with the flight path over the ROI. After determining the risk associated with the flight path the flight planning unit 106 can be configured to plan the flight path according to the determined data.

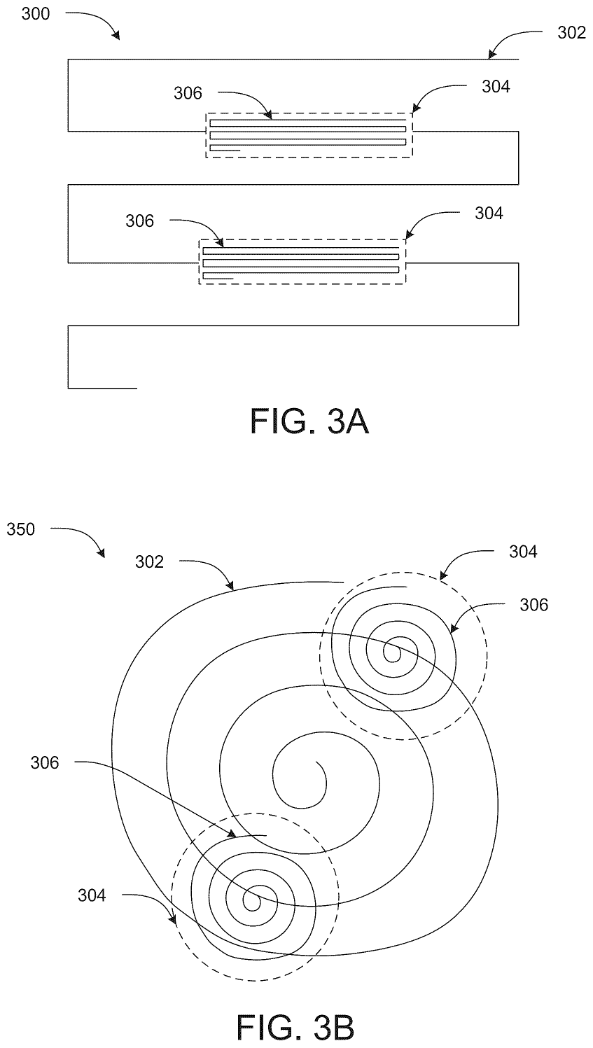

Further, the flight planning unit 106 can be configured to create a boundary 304 around the identified area of special interest (the area of special interest can also be referred to as boundary 304 (as shown in FIG. 3). The flight planning unit 106 can be configured to detect if the main flight path 302 (as shown in FIG. 3) intersects the created boundary 304 around the identified area of special interest. Upon determination that the main flight path 302 intersects the boundary 304, the flight planning unit 106 can create the additional flight path 306 covering the identified area of special interest to collect in-depth information related to the region of special interest.

In certain situations, it may happen that the main flight path 302 does not intersect the created boundary 304 around the identified area of special interest. In such situations, the flight planning unit 106 may ascertain a point on the created boundary 304 that is closest to the main flight path 302; and create the additional flight path 306 covering the identified area of special interest, such that the additional flight path 306 starts and terminates at the ascertained closest point on the boundary 304 around the identified area of special interest. Accordingly, the flight planning unit 106 may be configured to modify the main flight path 302 to take a detour towards the ascertained closest point on the boundary 304 around the identified area of special interest.

Referring to FIG. 1B, where a block diagram for the proposed system 150 for planning a real time flight path for a survey of a region of interest (ROI) is disclosed, the system 150 includes at least one unmanned aerial vehicle (UAV) 102 (at least one unmanned aerial vehicle interchangeably referred to as UAV 102) configured to fly over the ROI for collecting predefined data. The UAV 102 can include the flight planning unit 106 that can be configured to plan or create a real-time flight plan for surveying the selected ROI. The system 150 includes one or more sensors 152 operatively coupled with the flight planning unit 106 and a control unit 154. The one or more sensors 152 can be configured with the UAV 102 to capture one or more image of the ROI during the flight and transmit the captured data to the flight planning unit 106. The control unit 154 can be embedded within the flight planning unit 106 of the UAV 102 to control the one or more sensors 152 and other related component.

In an embodiment, the one or more sensors 152 can be any or a combination of an image acquisition unit, a ultra-violet camera, a gas detector and the likes. While the gas detector can detect presence of certain gases, the image acquisition unit and the ultra-violet camera can capture images of the ROI, which can be processed by the flight planning unit 106 and the control unit 154 to identify areas of special interest, such as area having low population, high population, smoke, fire, presence of crowd, and the likes.

In an embodiment, the flight planning unit 106 can be configured to actuate the one or more acquisition units 152 to capture data related to the ROI. The flight planning unit 106 can be configured to identify an area of special interest, such as but not limited to presence of a gathering, a crowd, a procession, etc., within the ROI based on processing the captured data related to the ROI. Further, the flight planning unit 106 creates a boundary 304 (as shown in FIG. 3) around the identified area of special interest and generates a real-time additional flight path for covering the identified area of special interest.

In an embodiment, the control unit 154 can be configured to control the one or more acquisition units 152 to change position and direction of the one or more acquisition units 152 during capture of data to identify the area of special interest within the ROI. The control unit 154 can be configured to obtain information on buildings, towers, population density, and mountains of the ROI from the captured data related to the ROI and correspondingly modify the additional real-time flight path of the UAVs 102.

In an example embodiment, the system 150 can be configured to monitor and manage on-going rallies/protests or another large gathering in the ROI. Further, identification of potential hotspots, and assessment of overall crowd dynamics to ensure the safety and security of both participants and law enforcement. The system 150 can be configured with algorithms to process the collected data by the one or more acquisition units 152 and one or more sensors or modules of the UAV 102. The system 150 can identify patterns within the crowd, recognize unusual behaviours, and highlight potential risks. By analysing historical data and comparing it with real-time information, the system 150 can predict and prevent potential issues, enabling proactive decision-making.

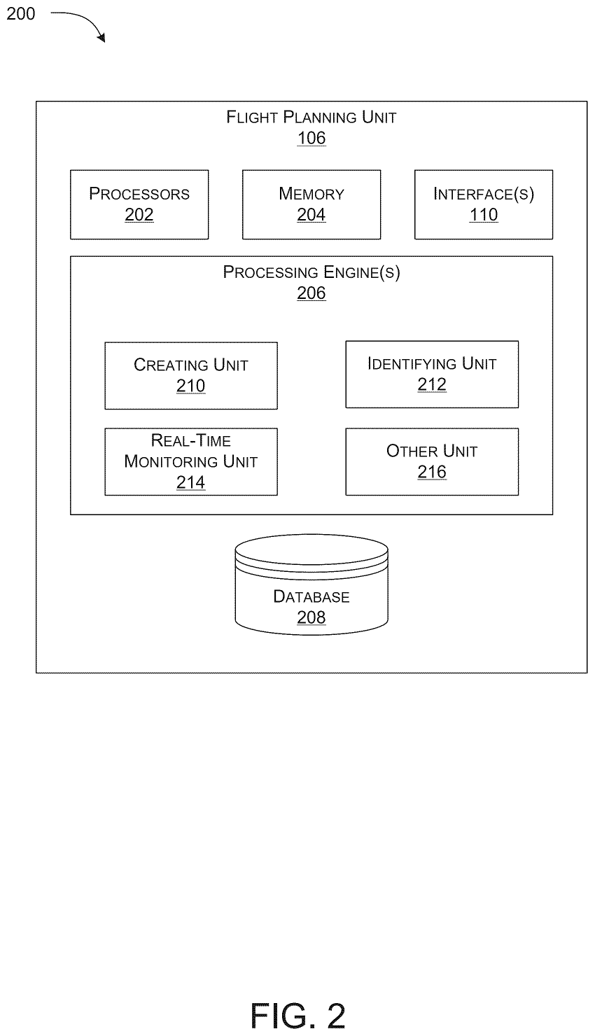

Referring to FIG. 2, a block diagram 200 depicts exemplary functional units of the flight planning unit 106 that can include one or more processor(s) 202, memory 204, interface(s) 110 (also referred to as user interface 110), processing engine(s) 206, and database 208. The one or more processor(s) 202 can be implemented as one or more microprocessors, microcomputers, microcontrollers, digital signal processors, central processing units, logic circuitries, and/or any devices that manipulate data based on operational instructions. Among other capabilities, the one or more processor(s) 202 are configured to fetch and execute computer-readable instructions stored in a memory 204 of the flight planning unit 106. The memory 204 can store one or more computer-readable instructions or routines, which may be fetched and executed to create or share the data units over a network service. The memory 204 can include any non-transitory storage device including, for example, volatile memory such as RAM, or non-volatile memory such as EPROM, flash memory, and the like.

The user interface 110 may include a variety of interfaces, for example, interfaces for data input and output devices, referred to as I/O devices, storage devices, and the like. The user interface 110 may facilitate communication with various devices coupled to the flight planning unit 106. The user interface 110 may also provide a communication pathway for one or more components of the flight planning unit 106. Examples of such components include but are not limited to, processing engine(s) 206 and database 208.

In an embodiment, the processing engine(s) 206 can be implemented as a combination of hardware and programming (for example, programmable instructions) to implement one or more functionalities of the processing engine(s) 206. In examples described herein, such combinations of hardware and programming may be implemented in several different ways. For example, the programming for the processing engine(s) 206 may be processor-executable instructions stored on a non-transitory machine-readable storage medium and the hardware for the processing engine(s) 206 may include a processing resource (for example, one or more processors), to execute such instructions. In the present examples, the machine-readable storage medium may store instructions that, when executed by the processing resource, implement the processing engine(s) 206. In such examples, the flight planning unit 106 can include the machine-readable storage medium storing the instructions and the processing resource to execute the instructions, or the machine-readable storage medium may be separate but accessible to the flight planning unit 106 and the processing resource. In other examples, the processing engine(s) 206 may be implemented by electronic circuitry. The database 208 can include data that is either stored or generated as a result of functionalities implemented by any of the components of the processing engine(s) 206.

In an embodiment, the processing engine(s) 206 can include a creating unit 210, an identifying unit 212, a real-time monitoring unit 214, and other unit(s) 216. The other unit(s) 216 can implement functionalities that supplement applications or functions performed by the flight planning unit 106 or the processing engine(s) 206.

According to an embodiment, the creating unit 210 can create the flight path for the UAV 102 to fly over the selected ROI for surveying to collect predetermined information. The creating unit 210 can create the flight path in any of the back-and-forth linear paths or spiral path flight paths or other pattern paths.

In one embodiment, the created flight path can support varying field-of-view of image sensor and/or supports varying perspective of the image sensor for obtaining varying mapping resolution. For example, while th new flight path is created, the camera's field of view activates the oblique mode of the camera where the camera moves in more than one direction continuously to capture the data, further in some areas based on some input trigger, the camera can zoom in and zoom out when needed. In an exemplary example, when a human is detected, the UAV's control system activates a deep search pattern for a threshold period of time, and in another example, the human (input) can trigger specific type of pattern flight path for detailed surveillance.

In one embodiment, if certain mission mode or application mode is chosen, based on that specific mission mode or application mode, the control system can identify the area of special interest within the selected ROI based on only the related special interest trigger datas. For example, when “crowd monitoring” application is selected, in that case the special area identification does not get triggerd by crowds but gets triggerred when a weapon is identified as a trigger, another example is when “Military Forest Surveillance” is chosen, the special interest area is triggered or identified when a single human is identified.

According to another embodiment, the identifying unit 212 can identify the area of special interest within the selected ROI based population data in-built within the map, a predefined population per unit area, and a geographical location identified by a user in the inputted map, or entered by the user in the user interface 110. Upon identification, the creating unit 210 can create/generate the additional flight path based on the identified data by merging it using various biased and linear techniques.

According to another embodiment, the real-time monitoring unit 214 can monitor real-time information to identify areas of special interest within the ROI based on the captured data related the ROI. Upon identification, the creating unit 210 can create the boundary around the identified area of special interest and then generate the real-time additional flight path for covering the identified area of special interest.

Referring to FIGS. 3A and 3B, an exemplary representation of a main flight path 300, 350 for covering the ROI. Further, FIG. 3A represents the back-and-forth flight path and the FIG. 3B represents the spiral flight for covering the ROI. The main flight path 302 and the additional flight path 306 can be any of the back-and-forth linear paths or spiral path flight paths, but not limited to only these two types, it can be any type of path such as a zig-zag or the like, which can be determined taking into considerations other parameters and the user requirements for survey application, like image overlap needed, survey type and/or the UAV's parameters like endurance ability, battery health, total battery charge and/or the geo-fence information of the area, height of the buildings in the area. The additional flight path 306 can be contiguous to the main flight path 302.

In an embodiment, the boundary 304 shapes can be created by the flight planning unit 106 or it can be created manually by the user on the user interface 110 in any shape, such as by drawing, or dragging and dropping a polygon shape from stored library of shapes, surround an area of interest of high or low population density within already selected location to be surveyed. The boundary 304 can be any of a polygon, rectangle, circular, or elliptical to separate or highlight the area of special interest within the ROI.

Accordingly, the present invention overcomes the earlier stated drawbacks, shortcomings, and limitations associated with the conventional systems by reducing the number of flights for surveying the ROI.

In accordance with the present invention the system 100, 150 incorporates advanced algorithms and real-time data analysis to modify or adjust flight paths based on the real-time population density within the ROI. The proposed system enhances operational efficiency, minimizes redundant flights, and provides a more dynamic and responsive solution to the demands of modern infrastructure surveying. The system 100 also improves the efficiency of data capture to produce the best quality orthomosaic.

In an exemplary embodiment, the safe mapping can be selected by the user; in such a case a dynamic flight path can be created which avoids the densely populated areas.

In an application of the concept of the present disclosure, the one or more sensors 152, such as an image acquisition unit or other gas detector etc., can be used for planning a real-time flight path for a survey of a region of interest (ROI). The control unit, such as the control unit 154 of the flight planning unit (106), can be operatively coupled with the one or more sensors 152 to actuate the one or more acquisition units 152 to capture data related to the ROI. The flight planning unit 106 can process the acquired data to identify an area of special interest within the ROI. The flight planning unit 106 can thereafter create, a boundary around the identified area of special interest; and generate, a real-time additional flight path for covering the identified area of special interest

In an embodiment, the area of special interest can be any or a combination of area with high population density, low population density, presence of a crowd, presence of smoke, presence of a gas, presence of fire, presence of one or more unidentifiable objects, presence of any in certain location, flooding, a specific type of terrain, a predefined specific location and accordingly, the flight planning unit 106 can, during processing of the acquired data, be configured to detect presence of crowd, smoke, fire and the likes, and link the same to occurrence of unusual happening. Thus the proposed system and method can help in using the aerial vehicle in riot control, fire management and other such happenings and natural calamities.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context dictates otherwise. Also, as used in the description herein, the meaning of “in” includes “in” and “on” unless the context clearly dictates otherwise.

Moreover, in interpreting the specification, all terms should be interpreted in the broadest possible manner consistent with the context. In particular, the terms “comprise” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

While the foregoing describes various embodiments of the invention, other and further embodiments of the invention may be devised without departing from the basic scope thereof. The scope of the invention is determined by the claims that follow. The invention is not limited to the described embodiments, versions or examples, which are comprised to enable a person having ordinary skill in the art to make and use the invention when combined with information and knowledge available to the person having ordinary skill in the art.

he present invention overcomes the above drawbacks, shortcomings, and limitations associated with existing electric vehicles and corresponding gearboxes.

The present disclosure overcomes the above drawbacks, shortcomings, and limitations associated with existing surveying methods and systems.

The present disclosure provides a system and method to reduce the number of flights for surveying selected regions of interest ROI.

The proposed disclosure provides a system and method to develop an improved, efficient, and cost-effective system and method for creating an additional flight path based on a trigger data of that selected ROI for an in-depth survey.

The present disclosure provides a system and method to design and develop an improved, efficient, and cost-effective system and method adapted to the additional flight path while flying on a primary flight path and acting on the additional flight path.

The present disclosure helps to generate an efficient flight path.

We claim:

1. A system (100) for planning a flight path for a survey of a region of interest (ROI), the system (100) comprising;
at least one unmanned aerial vehicle (UAV) (102) to fly over the ROI for collecting predefined data, the UAV comprising a flight control unit (104);
and a flight planning unit (106) operatively coupled with the flight control unit (104), the flight planning unit (106) comprising one or more processors (202) operatively coupled to a memory (204) storing instructions executable by the processor (202), wherein the flight planning unit (106) is configured to:
create, at least one main flight path covering the ROI;
identify, at least one area of special interest within the ROI;
create, at least one additional flight path for the identified area of special interest;
wherein the at least one additional flight path is contiguous to the at least one main flight path.

2. The system as claimed in claim 1, wherein the at least one area of special interest is any of an area with a trigger data.

3. The system as claimed in claim 1, wherein the flight planning unit (106) is configured to;
create a boundary around the identified area of special interest;
detect if the main flight path intersects the created boundary around the identified area of special interest; and
create the additional flight path covering the identified area of special interest, if it is detected that the main flight path intersects the boundary around the identified area of special interest.

4. The system as claimed in claim 1, wherein the flight planning unit (106) is configured to:
create a boundary around the identified area of special interest;
detect if the main flight path intersects the created boundary around the identified area of special interest;
ascertain, when it is detected that the main flight path does not intersects the created boundary around the identified area of special interest, a point on the created boundary around the identified area of special interest that is closest to the main flight path;
create the additional flight path covering the identified area of special interest, where the additional flight path starts and terminates at the ascertained closest point on the boundary around the identified area of special interest; and
modify the main flight path to take a detour towards the ascertained closest point on the boundary around the identified area of special interest.

5. The system (100) as claimed in claim 2, wherein the boundary shape is any of a polygon, rectangle, circular, or elliptical.

6. The system (100) as claimed in claim 1, wherein the main flight path and the additional flight path are any of a back-and-forth linear paths or spiral path flight paths.

7. The system (100) as claimed in claim 1, wherein the system (100) comprises a ground station (108) communicatively coupled to the flight planning unit (106), wherein the flight panning unit (106) is configured within any of the ground station (108) or the UAV (102).

8. The system (100) as claimed in claim 6, wherein the system (100) comprises a user interface (110) operatively coupled to the flight planning unit (106), wherein the user interface (110) is configured for inputting a map of the ROI.

9. The system (100) as claimed in claim 8, wherein the user interface (110) is configured within the ground station (108) or a user device (112).

10. The system (100) as claimed in claim 7, wherein the flight planning unit (106) identifies the area of special interest in the inputted map based on data inbuilt within the map.

11. The system (100) as claimed in claim 7, wherein the flight planning unit (106) identifies the area of special interest based on a geographical location identified by a user in the inputted map, or entered by the user in the user interface (110).

12. The system (100) as claimed in claim 2, wherein the flight planning unit (106) identifies the area of special interest in real time based on input from one or more sensors configured with the aerial vehicle.

13. The system (100) as claimed in claim 7, wherein the user interface (110) is configured for inputting a type of survey of the ROI, and based on the selected survey, a particular sensor or payload module among a plurality of sensors and payload modules, is activated upon reaching the ROI.

14. The system (100) as claimed in claim 1, wherein the system (100) comprises a risk analysis unit (114) communicatively coupled to the flight planning unit (106), the risk analysis unit (114) is configured to determine a risk associated with the flight path over the ROI.

15. The system (100) as claimed in claim 14, wherein the risk analysis unit (114) is configured to monitor one or more parameters including flight plan and battery charge, battery health, health of a body of the UAV, geo-fence information of the ROI to determine a risk associated with the flight path over the ROI.

16. A system (150) for planning a real-time flight path for a survey of a region of interest (ROI), the system (150) comprising;
at least one unmanned aerial vehicle (UAV) (102) configured to fly over the ROI for collecting predefined data, the UAV (102) comprising a flight planning unit (106);
one or more sensors (152) configured with the at least one UAV (102); and
a control unit (154) embedded within the flight planning unit (106) of the at least one UAV (102) and operatively coupled with the one or more sensors (152), wherein the flight planning unit (106) comprises one or more processors (202) operatively coupled to a memory (204) storing instructions executable by the processor (202), wherein the flight planning unit (106) is configured to:
actuate the one or more sensors (152) to capture one or more data related to the ROI;
identify, an area of special interest within the ROI based on the captured data related to the ROI;
create, a boundary around the identified area with special interest; and
generate, a real-time additional flight path for covering the identified area of special interest.

17. The system (150) as claimed in claim 16, wherein the area of special interest is any or a combination of area with higher population density, lower population density, presence of a crowd, presence of smoke, presence of a gas, presence of fire, presence of one or more unidentifiable objects, flooding.

18. The system (150) as claimed in claim 16, wherein the control unit (154) is configured to control the one or more sensors (152) to change position and direction of the one or more sensors (152) during capture of data to identify the area of special interest within the ROI.

19. The system (150) as claimed in claim 16, wherein the control unit (154) is configured to obtain information on buildings, towers, population density, and mountains of the ROI from the captured data of the ROI and correspondingly modify the additional flight path of the UAVs (102).
